(19) United States
(12) Patent Application Publication
(10) Pub. No.: US 2014/0019460 A1
(43) Pub. Date: Jan. 16, 2014

(54) TARGETED SEARCH SUGGESTIONS

(71) Applicants: Hemanth Sambrani, Bangalore (IN); Sudharsan Vasudevan, Sunnyvale, CA (US); Caridy Patino, Miami, FL (US); Ethan Batraski, Foster City, CA (US); Jeremy Anderson, San Francisco, CA (US)

(72) Inventors: Hemanth Sambrani, Bangalore (IN); Sudharsan Vasudevan, Sunnyvale, CA (US); Caridy Patino, Miami, FL (US); Ethan Batraski, Foster City, CA (US); Jeremy Anderson, San Francisco, CA (US)

(73) Assignee: YAHOO! INC., Sunnyvale, CA (US)

(21) Appl. No.: 13/592,402

(22) Filed: Aug. 23, 2012

(30) Foreign Application Priority Data
Jul. 12, 2012 (IN) 2834/CHE/2012

(51) Int. Cl. G06F 17/30

(52) U.S. Cl. CPC G06F 17/3064; G06F 17/3053
USPC 707/749; 707/767

(57) ABSTRACT

Methods and systems for providing search suggestions are disclosed. A webpage is analyzed. Terms from the webpage are extracted based on analyzing the webpage. At least one suggestions is generated based on the extracted terms, wherein each of the at least one suggestion is actionable.

### CROSS-REFERENCE TO RELATED APPLICATIONS

The present application claims priority to Indian Application Serial No. 2834/CHE/2012, filed 12 Jul. 2012, which is incorporated herein by reference in its entirety.

### FIELD

The present disclosure relates to methods, systems and programming for providing search suggestions. More particularly, the present disclosure is directed to methods, systems, and programming for providing search suggestions and corresponding web page previews.

### BACKGROUND OF THE INVENTION

When users of web search engines or browsers open or initiate their search engine, they may be presented with search suggestions. The search suggestions may oftentimes contain a random sampling of most searched terms or topics of interest to the general public. However, the search suggestions are not tailored to the actual user of the web browser or search engine. Thus, search suggestions may largely be ignored by most users because they have no interest in the topics or terms which make up the search suggestions.

Furthermore, the search suggestions are often displayed as a list in an order that is not relevant to the interests of the user. Thus, even if a user may be interested in search suggestions, it is often quicker for a user to simply enter a new search term rather than sift through search suggestions to possibly find a topic of interest.

Additionally, search results are often provided in an fashion where navigation of results is not entirely convenient for the user. For example, search results may be displayed as a list of search results with no way for the user to determine which result is the most relevant, and which search results are associated with web pages that are active or indicative of what the user is looking for.

### SUMMARY

The embodiments described herein relates to methods, systems and programming for providing search suggestions. More particularly, the present disclosure is directed to methods, systems, and programming for providing search suggestions and corresponding web page previews.

In an embodiment a method implemented on at least one computing device, each computing device having at least one processor, storage, and a communication platform connected to a network for providing search suggestions is disclosed. A webpage is analyzed. Terms from the webpage are extracted based on analyzing the webpage. At least one suggestions is generated based on the extracted terms, wherein each of the at least one suggestion is actionable.

In an embodiment, a system for providing search suggestions is disclosed. The system comprises an analysis unit, an extraction unit, and a suggestion generation unit. The analysis unit is configured for analyzing a webpage. The extraction unit is configured for extracting terms from the webpage based on analyzing the webpage. The suggestion generation unit is configured for generating at least one suggestion based on the extracted terms, wherein each of the at least one suggestion is actionable.

Other concepts relate to software for implementing adaptive application searching. A software product, in accord with this concept, includes at least one machine-readable non-transitory medium and information carried by the medium. The information carried by the medium may be executable program code data regarding parameters in association with a request or operational parameters.

In an embodiment, a machine readable and non-transitory medium having information recorded thereon for providing search suggestions, where when the information is read by the machine, causes the machine to analyze a webpage, extract terms from the webpage based on analyzing the webpage, and generate at least one suggestion based on the extracted terms, wherein each of the at least one suggestion is actionable.

Additional advantages and novel features will be set forth in part in the description which follows, and in part will become apparent to those skilled in the art upon examination of the following and the accompanying drawings or may be learned by production or operation of the disclosed embodiments. The advantages of the present embodiments may be realized and attained by practice or use of various aspects of the methodologies, instrumentalities and combinations set forth in the detailed description set forth below.

### BRIEF DESCRIPTION OF THE DRAWINGS

FIG. 1 depicts an exemplary view of search results including search suggestions, rich results, and web page previews, in accordance with an embodiment of the present disclosure.

FIG. 2 depicts a high level exemplary system diagram of a system for providing search suggestions, in accordance with an embodiment of the present disclosure.

FIG. 3 depicts inputs and outputs of an analysis unit, in accordance with an embodiment of the present disclosure.

FIG. 4 depicts inputs and outputs of an extraction unit, in accordance with an embodiment of the present disclosure.

FIG. 5 depicts inputs and outputs of a suggestion generation unit, in accordance to an embodiment of the present disclosure.

FIG. 6 depicts inputs and outputs of a web page preview unit, in accordance with an embodiment of the present disclosure.

FIG. 7 depicts a flowchart of an exemplary process for generating search suggestions, in accordance with an embodiment of the present disclosure.

FIG. 8 depicts a flowchart of an exemplary process for ranking search suggestions, in accordance with an embodiment of the present disclosure.

FIG. 9 depicts a high level exemplary system diagram of a system 900 in which a search engine and search suggestion engine are deployed for providing search suggestions, in accordance with an embodiment of the present disclosure.

FIG. 10 depicts a high level exemplary system diagram of a system 1000 in which a search engine and search suggestion engine are deployed for providing search suggestions, in accordance with an embodiment of the present disclosure.

FIG. 11 depicts a general computer architecture on which the present embodiments can be implemented and has a functional block diagram illustration of a computer hardware platform which includes user interface elements.

### DETAILED DESCRIPTION

In the following detailed description, numerous specific details are set forth by way of example in order to provide a thorough understanding of the relevant embodiments described herein. However, it should be apparent to those skilled in the art that the present embodiments may be practiced without such details. In other instances, well known methods, procedures, components and/or circuitry have been described at a relatively high-level, without detail, in order to avoid unnecessarily obscuring aspects of the embodiments described herein.

The present disclosure relates to methods, systems and programming for providing search suggestions. More particularly, the present disclosure is directed to methods, systems, and programming for providing search suggestions and corresponding web page previews. A webpage that is currently being browsed by a user may be analyzed to determine terms of interest. These terms may represent words or phrases which are terms that may be used for searching, and to which particular meanings are associated. After determining terms of interest, these terms may be extracted from the webpage, based on use of trained classifiers. The classifiers are utilized to determine the probability that these terms are ambiguous or to determine the probability that the terms represent a theme. If the terms are ambiguous, the terms may undergo disambiguation processing to determine a specific topic, phrase, or other term that the terms may relate to. If the terms are determined to represent a theme, the terms under a same theme may be associated with one another. Based on the extracted terms, search suggestions are generated. The search suggestions may additionally be ranked based on parameters relating to search inducingness factor. This represents the level of likelihood that the search suggestion is of interest to the user based on their browsing of the webpage from which the terms were extracted from.

The search suggestions may be displayed for the user within a browser environment or via an application. The search suggestions may be displayed in ranked order, along with a rich results display and a corresponding web page preview display which shows web page previews corresponding to the search suggestions.

Web page previews in the form of snapshots are rendered instantaneously or in real time as a search suggestion is selected or activated. As discussed, the search suggestions represent search terms or search phrases based on terms found within a current webpage being viewed or browsed by a user. The rich result represents a targeted search result that is specifically associated with the selected search suggestion in first display area. The web page previews are represented by snapshots which are viewable and actionable. Each snapshot links to a corresponding web page URL, and each snapshot represents a current, updated view of that particular web page URL.

In this manner, users can browse web pages and view search suggestions with corresponding web page previews. As the search suggestions are targeted to the user based on the current web page being browsed, and as web page previews for the search suggestions are shown, the user receives a unique search experience as not only are the search suggestions targeted, but corresponding web page previews in the form of viewable and actionable interactive snapshots are displayed for the user to utilize. Screenshots also enable users to make a visual decision about whether or not the search suggestion is truly something they are interested in.

The web page snapshots are refreshed continuously so that the web page snapshots always reflect a direct representation of what is displayed when visiting a particular web page URL.

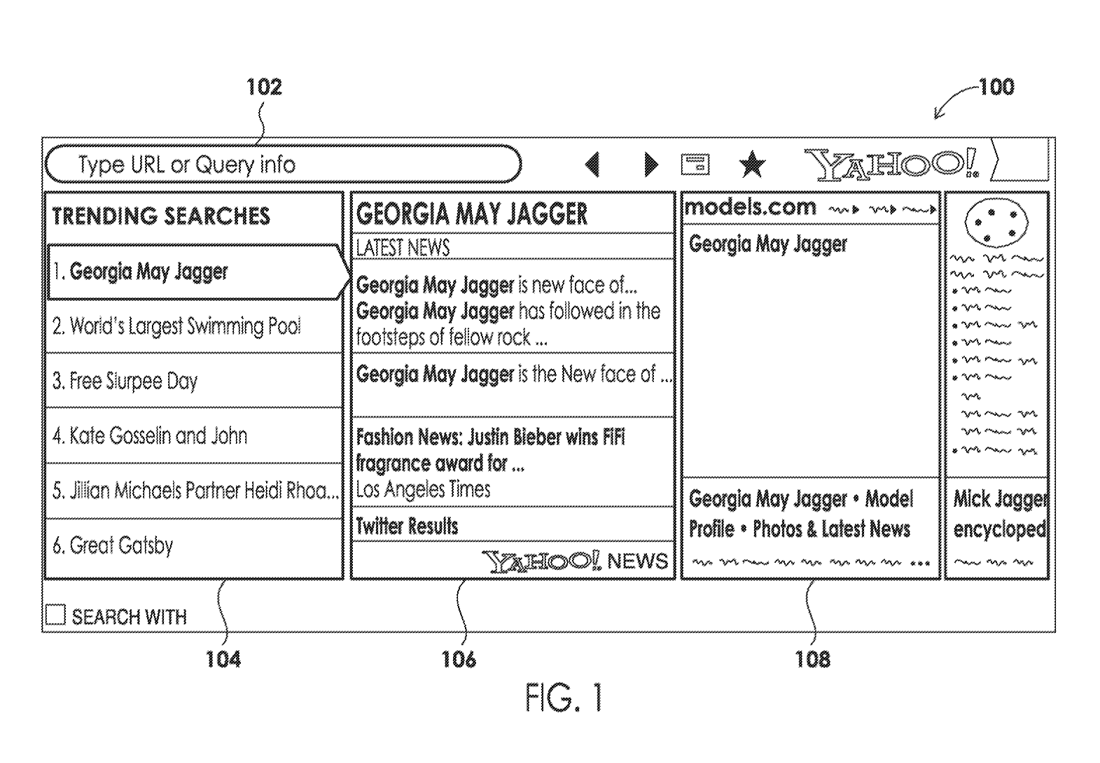

FIG. 1 depicts an exemplary view of search results including search suggestions, rich results, and web page previews, in accordance with an embodiment of the present disclosure. View 100 comprises a search query box 102 where an input may be entered, such as a keyword, a search term, and number of characters, any number of numerals, any number of words, phrases, abbreviations, acronyms, stock ticker symbols, website addresses, or any combination thereof. As the present disclosure is focused on search suggestions based on a current website browsed by a user, search query box 102 will not be described in detail.

View 100 further includes a trending searches or search suggestions display area 104. Display area 104 displays search suggestions or trending search topics based on an analysis and extraction of terms from a current website browsed by the user.

Rich result display area 106, displays rich results that are related to a selected search suggestion from display area 104. Web page preview display area 108 displays a plurality of web previews, each web preview in the form of a snapshot that is viewable and actionable and linking to a corresponding web page URL. These web page previews are associated with the selected search suggestion of display area 104. Thus, rich result display area 106 and web page preview display area 108 will updated based on which search suggestion is selected from display area 104.

All display areas 104, 106, and 108 are furthermore navigable based on detection of an input within the respective display areas. For example, display area 108 includes coordinates at each point within display area 108. Detection of an input at particular coordinates within display area 108, the input being from peripheral devices or as a result of tactile stimulation causing a capacitive, resistive, or wave input, will cause the web page previews to move such that further web page previews may be displayed. Similarly, detection of input at particular coordinates within display area 104 and display area 106 will effect selection of search suggestions or rich results.

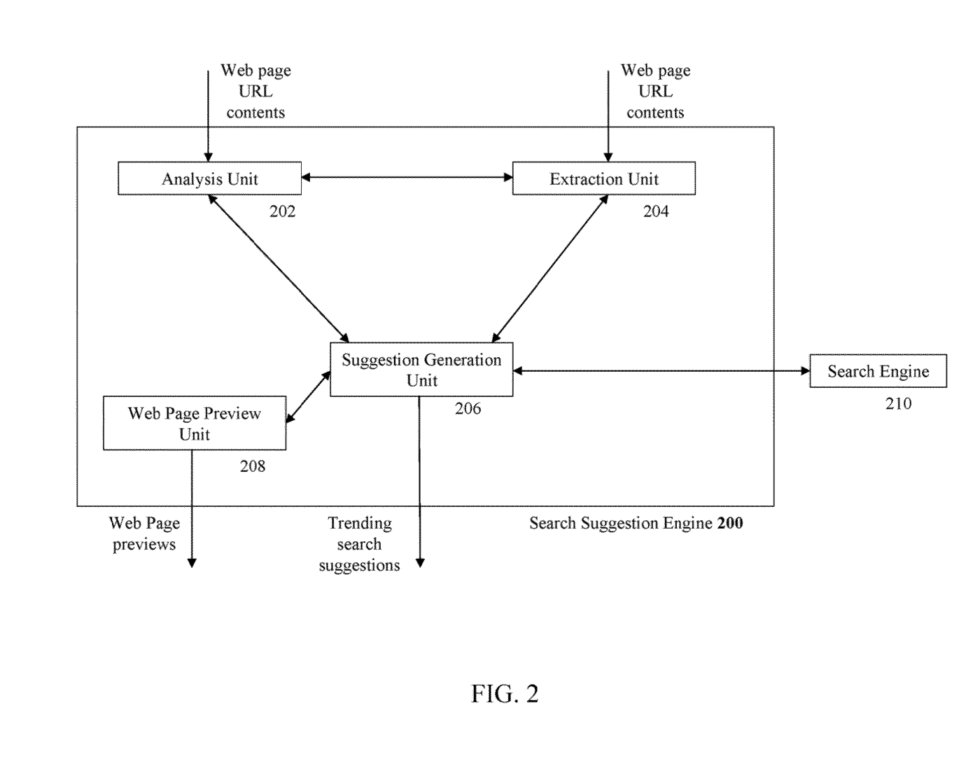

FIG. 2 depicts a high level exemplary system diagram of a system for providing search suggestions, in accordance with an embodiment of the present disclosure. The system shown in FIG. 2 may be referred to as search suggestion engine 200. Search suggestion engine 200 may comprise an analysis unit 202, extraction unit 204, suggestion generation unit 206, and web page preview unit 208.

Analysis unit 202 is configured to analyze a webpage that is being browsed by a user. When search suggestion engine 200 detects a browsing of a web page by a user, the web page URL contents of the web page being browsed are requested by analysis unit 202. The web page URL contents may be transmitted to analysis unit 202 from a web server, from a local user machine, or from any machine or server capable of hosting and storing web content.

Once the web page URL contents are received by analysis unit 202, analysis unit 202 analyzes the web page URL contents to determine certain terms of interest on the webpage. Analysis unit 202 determines all searchable terms from the web page URL contents and analyzes them to find terms of interest based on search inducingness. Search inducingness may be defined as a factor that indicates which terms are the ones most likely to be searched by the user based on the current content of the web page being browsed. The terms may be phrases such as “Occupy Wall Street” or words such as “Apple” which may carry multiple meanings. Once terms of interest have been determined, the terms are sent for extraction by extraction unit 204.

Extraction unit 204 receives the analyzed terms and proceeds to extract the terms to be used for generating search suggestions. Extraction of the terms is based on at least one trained classifier. A first classifier may be configured to detect the probability of an ambiguity in a term, and a second classifier may be configured to detect the probability of a term representing a theme.

The first classifier attempts to disambiguify ambiguous phrases or terms. The first classifier as applied, determines the various contexts available to certain phrases or terms by determining whether a single term links to one or more descriptors, and determines which of the descriptors is most applicable to the term. For example, if the term “Apple” is found within the web page contents, various contexts may be applied to the term. “Apple” may be associated with Steve Jobs, with iPhones, or with foods. According to the first classifier, the term “Apple” may already be assigned to categories, such as Steve Jobs, smartphones, and food. Based on these categories and the remaining terms of interest from the web page URL contents, the extraction unit 204 determines which term to extract with an assigned category that will be used to generate the search suggestions. If the web page being browsed, for example, is a grocery store website, it is likely that the term “Apple” will be extracted with the category of food attached.

Disambiguation is required whenever, for a given term or phrase, there is more than one existing search topic for. A determination may be made whether there is a primary topic to which the term should lead. A topic may be primary for a term with respect to usage. For example, “Occupy Wall Street” quickly became a much used phrase during 2011. A topic may also be primary with respect to long-term significance, such as, for example, the phrase “Independence Day.” Determination of a primary topic may be determined based on the number of occurrences, relatedness with other terms, and also the click worthiness of the term, such as the number of times the term has been searched or been selected in a given time frame by other users searching for similar terms. If there is no primary topic, secondary topics may be introduced based on the first classifier, and the term will be extracted for search suggestions based on any associated secondary topic.

The second classifier to detect probability of a term representing a theme. The second classifier provides a probability that a term is part of a recurring theme which will be used to focus the search suggestions. This involves determining if the term is an anchor that can be used as being representative of the theme, and thus applying the theme to the remainder of the terms to formulate the search suggestions. Determination of this probability is based on relatedness of terms, the number of occurrences of the term, and the distribution of the term within the web page URL contents.

The extracted terms from extraction unit 204 may be transmitted to suggestion generation unit 206 in order to generate search suggestions based on all of the extracted terms. Suggestion generation unit will, based on a plurality of parameters and other data that may be provided by a search engine 210, generate a list of trending searches related to the extracted terms from the web page URL contents.

The list of search suggestions is generated based on parameters such as the click worthiness of a search term, number of queries associated with the particular search term, a buzz or trending score that identifies the occurrence and frequency of search terms related to trending topics, a vitality score representing the longevity of a search term, and the availability of rich content associated with the search term. Each of these parameters may be deemed to represent a search inducingness factor representing the likelihood that the user is interested in a provided search suggestion or term. The search suggestions may be ranked based on these parameters to present a user a list of search terms that are most likely to be of interest to the user based on the current web page being browsed. The parameters may be weighted accordingly to accord greater weight to certain parameters which may be more useful for determining search inducingness.

Ranking of search suggestions may also be based on relevance of the suggestions. Relevance of search suggestions may be improved by a measure of aboutness, which filters concepts that are impertinent to the largest duster of coherent concepts. For example, the user may be browsing a web page on the topic of tennis. Certain search suggestions that may be offered to the user based on suggestion generation unit 206 may include “Wimbledon”, “Roger Federer”, and “Adidas Tennis.” The search suggestions may also include “Racquetball.” However, as racquetball is not as relevant to the broad topic of tennis as the other search suggestions, the search suggestion “Racquetball” will be moved lower within the search suggestion rankings. Thus, ranking based on aboutness culls out concepts that have a low association with other concepts in context.

Accordingly, after suggestion generation unit 206 has successfully generated suggestions based on extracted terms from extraction unit 204, suggestion generation 206 may continually fine tune the search suggestions by re-ranking them based on the aforementioned parameters, and based on relevance.

The search suggestions are provided by suggestion generation unit 206 to a user in a form where they may be displayed along side rich results and web page previews that correspond with the search suggestions.

Web page preview unit 208 may receive search suggestions from suggestion generation unit 206. Based on the search suggestions, web page preview unit 208 will generate the appropriate web page preview that corresponds to each search suggestion. All of the search suggestions, and web page previews are provided in a viewable and actionable form such that they are easily navigable and responsive to user input on a variety of devices including personal computing devices, and mobile devices such as smartphones, tablets, netbooks, and any other computing device capable of browsing web pages and accessing a search engine to provide users with search results.

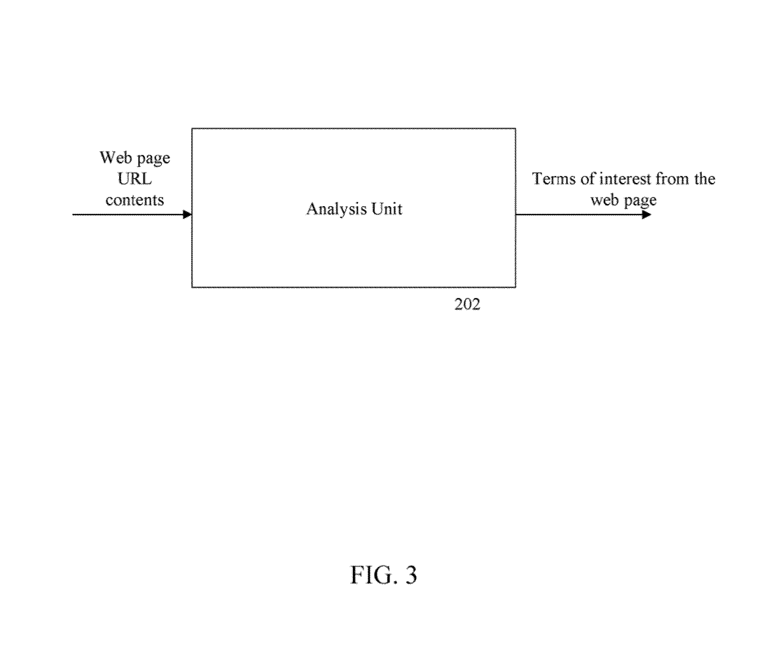

FIG. 3 depicts inputs and outputs of an analysis unit, in accordance with an embodiment of the present disclosure. Analysis unit 202, as shown receives as input, web page URL contents from a web page that is currently being browsed by a user. The user may be using a search engine or application that communicates with search suggestion engine 200. This facilitates transmittal of the web page URL contents from wherever the web page URL contents are stored or hosted to analysis unit 202. After the input of web page URL contents is received by analysis unit 202, analysis unit 202 undertakes an analysis of all of the terms of the web page URL contents. This analysis results in an output of terms of interest from the web page URL contents. The terms of interest may be defined as terms which a user browsing the web page may be interested in, and thus these terms are used as the basis of producing search suggestions for the user based on their currently browsed web page. The terms of interest are provided to an extraction unit 204 to extract the terms from the webpage.

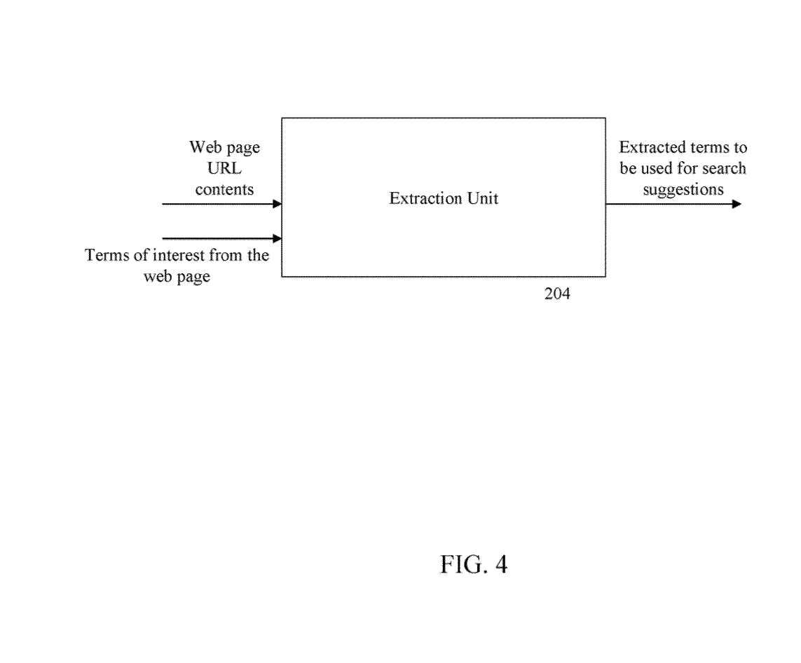

FIG. 4 depicts inputs and outputs of an extraction unit, in accordance with an embodiment of the present disclosure. Extraction unit 204, as shown receives as input web page URL contents and terms of interest from the web page. Web page URL contents are received at extraction unit 204 in a similar fashion as they are received by analysis unit 202. Terms of interest from the web page are received by extraction unit 204 from analysis unit 202. Using the terms of interest, extraction unit 204 extracts terms from the webpage to be used for search suggestions based on the analysis of the web page and terms of interest provided by analysis unit 202. As described above, extraction unit 204 extracts terms for use by suggestion generation unit 206 by relying on trained classifiers. The trained classifiers assist with extraction by performing disambiguation on the terms, and also detecting anchor terms or terms that may represent a theme prevalent within the web page. All extracted terms that have been extracted by extraction unit 204 and that are deemed to be used for search suggestions are provided to suggestion generation unit 206.

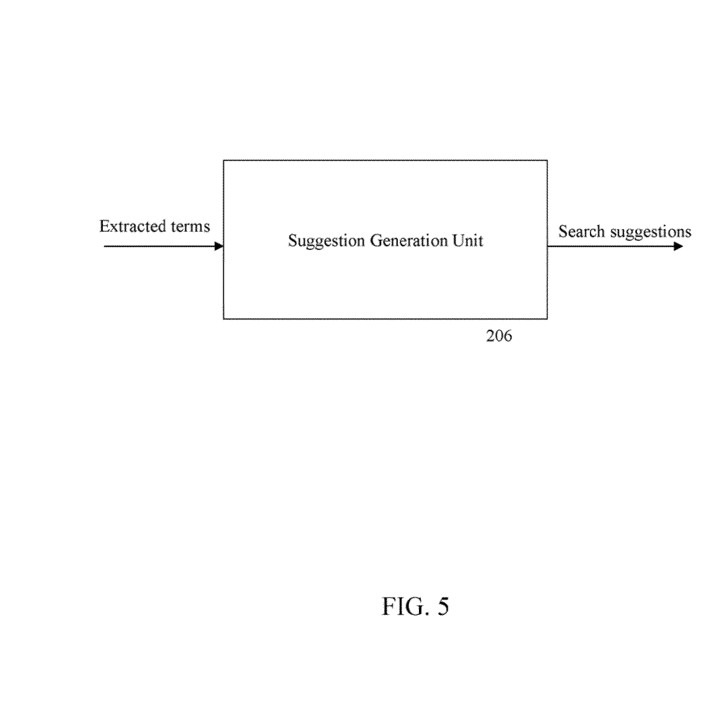

FIG. 5 depicts inputs and outputs of a suggestion generation unit, in accordance to an embodiment of the present disclosure. Suggestion generation unit 206, as shown receives as input extracted terms from extraction unit 204. The extracted terms are used for generating search suggestions for users based on the extracted terms. These search suggestions are specifically targeted to the user because they are based upon the current web page being browsed by the user. The generated search suggestions may further be ranked based on parameters as described above. These parameters may be weighted to fine tune the rankings and to further filter out results that have a low relevance. The parameters represent a search inducingness factor which represents the level of likelihood that the search suggestion is of interest to the user based on their browsing of the webpage from which the terms were extracted from. Suggestion generation unit 206 provides search suggestions as output to a user browsing the web page where the originally extracted terms relate to. The search suggestions may be reranked based on the relevance of the search suggestions. The search inducingness factors may include a number of queries for a particular search suggestion, a total number of queries for a search suggestion, a buzz index or score which indicates what search suggestions may be trending, a vitality score, and availability of rich content. Thus, not only will suggestion generation unit 206 provide search suggestions that are pertinent to the web page being browsed, but also trending suggestions based on the web page URL content. An example relating to a tennis web site was described above. However, to further demonstrate the directedness of the search suggestions to the user, browsing a tennis site during the month of July, for example, will produce trending search suggestions related to two major tournaments played during July, the “Roland Garros” event, and “Wimbledon” event. As these search suggestions will be appropriately trending, these search suggestions may be ordered higher in a ranking list of search suggestions that is presented to a user.

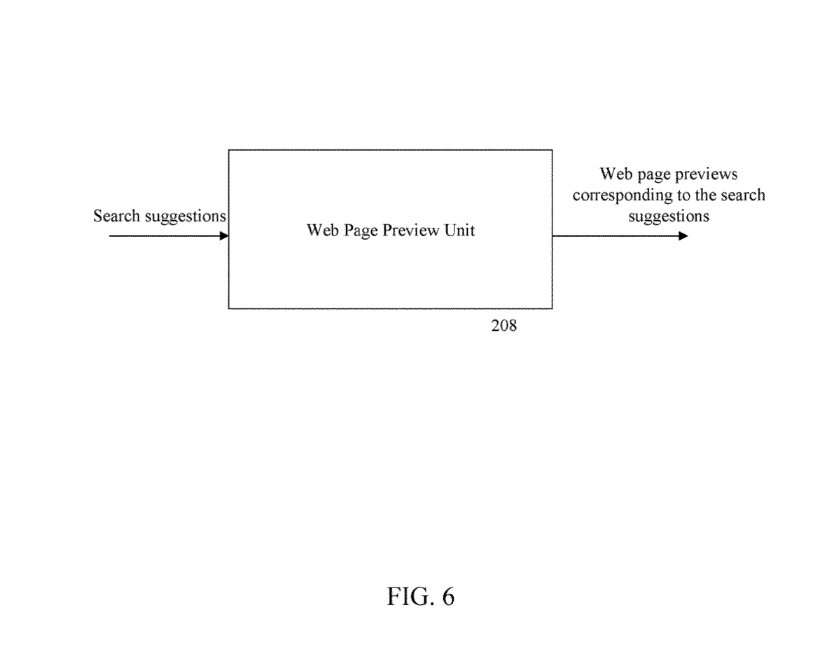

FIG. 6 depicts inputs and outputs of a web page preview unit, in accordance with an embodiment of the present disclosure. Web page preview unit 208, as shown receives as input search suggestions from suggestion generation unit 206. On the basis of these search suggestions, web page preview unit 208 generates or retrieves web page previews that are continuously refreshed and which correspond to the search suggestions. These web page previews may then be provided as output, from web page preview unit 208 to a user that is viewing search suggestions provided from suggestion generation unit 206.

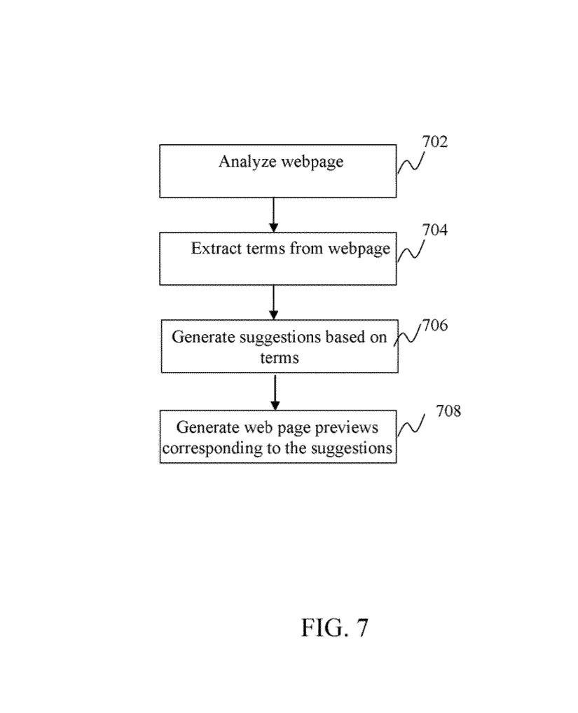

FIG. 7 depicts a flowchart of an exemplary process for generating search suggestions, in accordance with an embodiment of the present disclosure. At 702, a webpage is analyzed. Analysis of the webpage includes determining terms of interest on the webpage. As discussed above, analysis of the webpage may be carried out by analysis unit 202.

At 704, terms are extracted from the webpage based on analysis of the webpage. Extraction of terms may be based on classifiers, which determine ambiguity in terms to disambiguify them and also detect a probability that terms represent themes. As discussed above, extraction of terms may be carried out by extraction unit 204.

At 706, suggestions are generated based on the extract terms. Each of the suggestions are actionable to allow a user to select the suggestion to generate corresponding web page previews. Generation of suggestions or search suggestions may be based on parameters that represent search inducingness factors. The search suggestions may further be ranked based on an algorithm taking into account the parameters. The parameters may be weighted accordingly. Furthermore, rankings of the generated suggestions may be based upon determining a relevance of each of the suggestions in comparison with the other suggestions or with the general theme of the web page being browsed. As discussed above, suggestions are generated by suggestion generation unit 206.

At 708, web page previews are generated corresponding to the suggestions. As described above, web page preview unit 208 is responsible for generating web page previews and providing them with users to complement the search suggestions provided by suggestion generation unit 206.

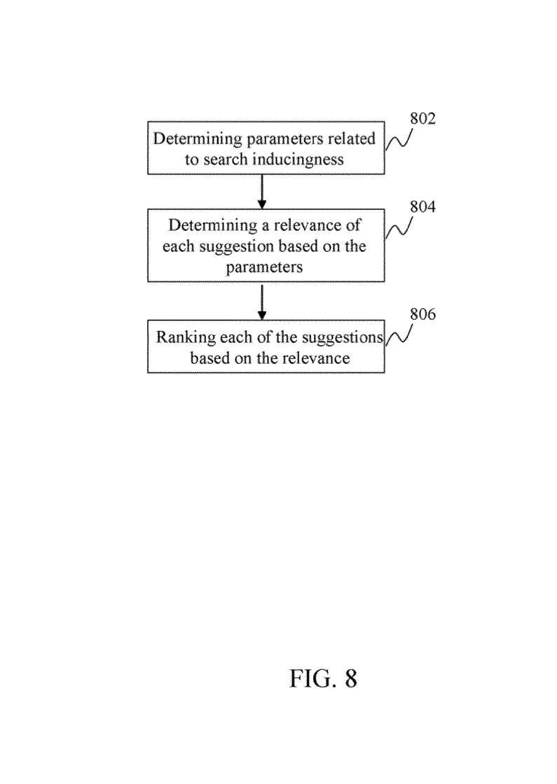

FIG. 8 depicts a flowchart of an exemplary process for ranking search suggestions, in accordance with an embodiment of the present disclosure. At 802, parameters related to search inducingness are determined by suggestion generation unit 206.

At 804, a relevance of each suggestion based on the parameters is determined.

At 806, each of the suggestions is ranked based on the relevance.

In this manner, suggestion generation unit 206 provides search suggestions to the user that are most likely to be of interest to the user. In addition, not only are these search suggestions likely to be of interest to the user, but are also ranked based on their relevance at large and based on the parameters which may indicate which search suggestions are currently trending and are topics of interest to the public at large as well as the user, based on the user's browsing of a certain web site.

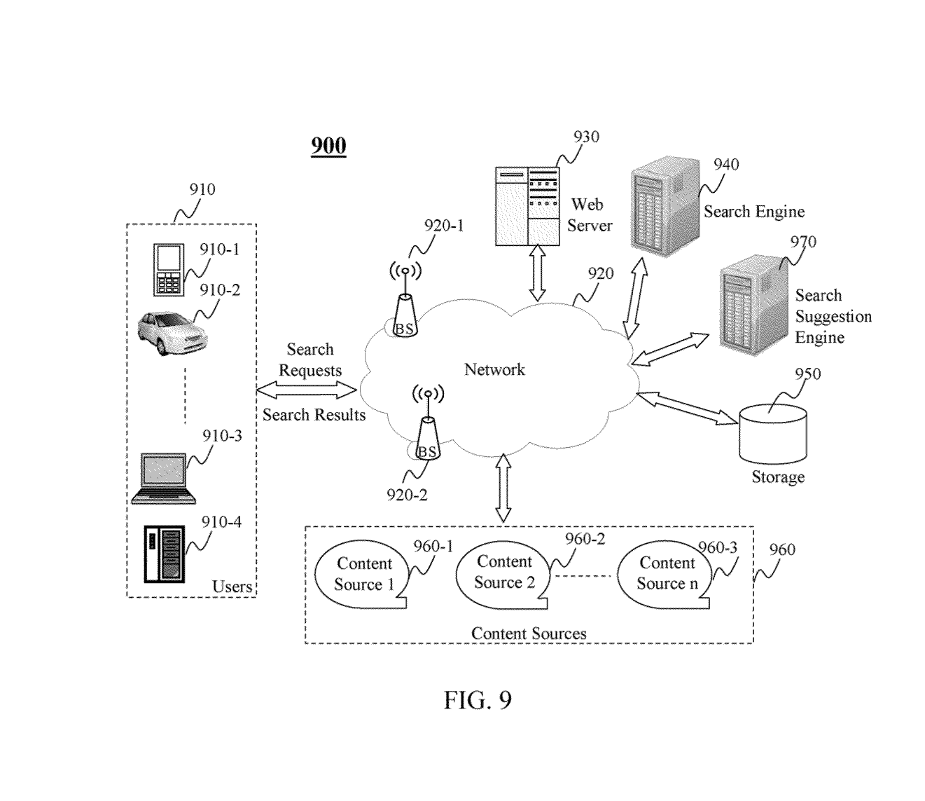

FIG. 9 depicts a high level exemplary system diagram of a system 900 in which a search engine and search suggestion engine are deployed for providing search suggestions, in accordance with an embodiment of the present disclosure. FIG. 9 is a high level depiction of an exemplary system 900 in which a web server and search engine are deployed to provide search suggestions, in accordance with an embodiment of the present disclosure. Exemplary system 900 includes users 910, network 920, web server 930, content sources 960, search engine 940, storage 950, and search suggestion engine 970. Network 920 can be a single network or a combination of different networks. For example, a network may be a local area network (LAN), a wide area network (WAN), a public network, a private network, a proprietary network, a Public Telephone Switched Network (PTSN), the Internet, a wireless network, a virtual network, or any combination thereof. A network may also include various network access points, e.g., wired or wireless access points such as base stations or Internet exchange points 920-1, . . . 920-2, through which a data source may connect to in order to transmit information via the network.

Users 910 may be of different types such as users connected to the network via desktop connections (910-4), users connecting to the network via wireless connections such as through a laptop (910-3), a handheld device (910-1), or a built-in device in a motor vehicle (910-2). A user may run applications and data provided by web server 930, search engine 940, or any of content sources 960. Thus, applications and data may be provided from web server 930, search engine 940, or any of content sources 960 through network 920. Once a user is running an application on their device, the user may send instructions or search requests via the application to web server 930, search engine 940, search suggestion engine 970, or any of content sources 960 through network 920. Users 910 may additionally submit requests to web server 930, search engine 940, or search suggestion engine 970 without usage of an application. Based on the requests, to web server 930, search engine 940, or search suggestion engine 970 may provide results to users 910. The results may include search suggestions in a first display area, web page previews with snapshots being viewable and actionable links to web page URLs in a second display area, and rich results in a third display area.

The content sources 960 include multiple content sources 960-1, 960-2, . . . , 960-3. A content source may correspond to a web page host corresponding to an entity, whether an individual, a business, or an organization such as the USPTO represented by USPTO.gov, a content provider such as Yahoo.com, or a content feed source such as Twitter or blog pages. It is understood that any of these content sources may be associated with search suggestions provided to users 910. For example, a search suggestion may correspond to a snapshot linking to a content source. When a user activates the snapshot, the user will then be provided with a web browser view of the web page of the content source. Web server 930, search engine 940, or search suggestion engine 970 may access information from any of content sources 960 and rely on such information to provide search suggestions, web page previews, rich results, web page snapshots, respond to requests, and provide results. Web server 930, search engine 940, or search suggestion engine 970 may also access additional information, via network 920, stored in storage 950, which may contain snapshots for web page previews or search indexes to assist in generating search suggestions. Storage 950 may also include a search suggestions database and searchable index database.

In exemplary system 900, search engine 940 search suggestion engine 970 receives web page URL contents for analysis. Based on the analysis, terms are extracted from the webpage. At least one suggestion is generated based on the extracted terms. The generated terms are provided such that they are actionable and correspond with web page previews.

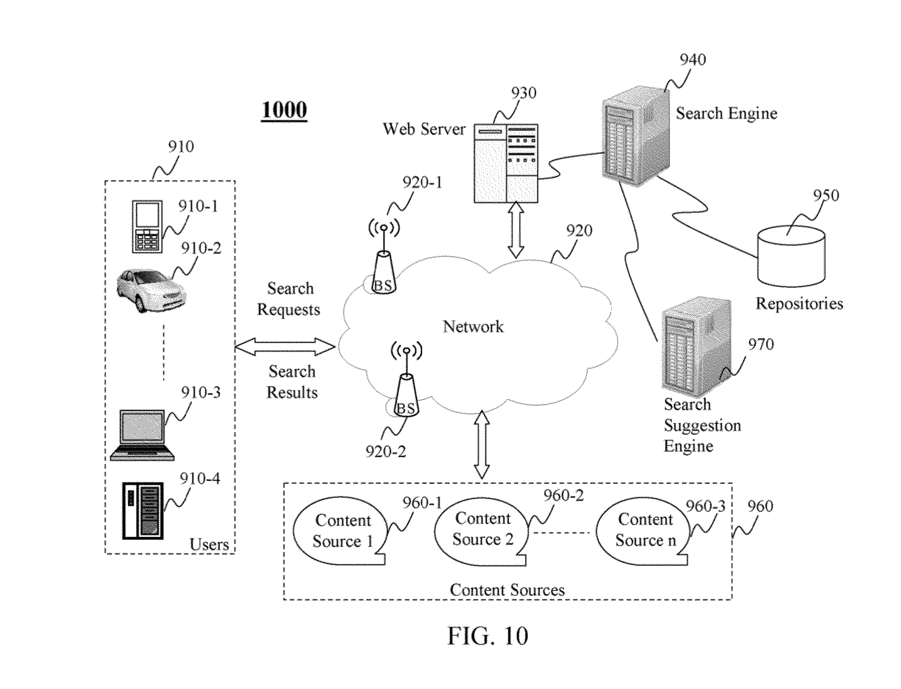

FIG. 10 depicts a high level exemplary system diagram of a system 1000 in which a search engine and search suggestion engine are deployed for providing search suggestions, in accordance with an embodiment of the present disclosure. FIG. 10 is a high level depiction of an exemplary system 1000 in which a search engine and search suggestion engine are deployed to provide search suggestions, in accordance with an embodiment of the present disclosure. In this embodiment, search engine 940 serves as a backend system of web server 930. In turn, search suggestion engine 970 serves as a backend to search engine 940. All communication to and from search engine 940 and to and from search suggestion engine 970 is sent and received through web server 930.

To implement the embodiments set forth herein, computer hardware platforms may be used as hardware platform(s) for one or more of the elements described herein (e.g., web server 930, search engine 940, search suggestion engine 200 and 970, analysis unit 202, extraction unit 204, and suggestion generation unit 206). The hardware elements, operating systems and programming languages of such computer hardware platforms are conventional in nature, and it is presumed that those skilled in the art are adequately familiar therewith to adapt those technologies to implement any of the elements described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment, and as a result the drawings are self-explanatory.

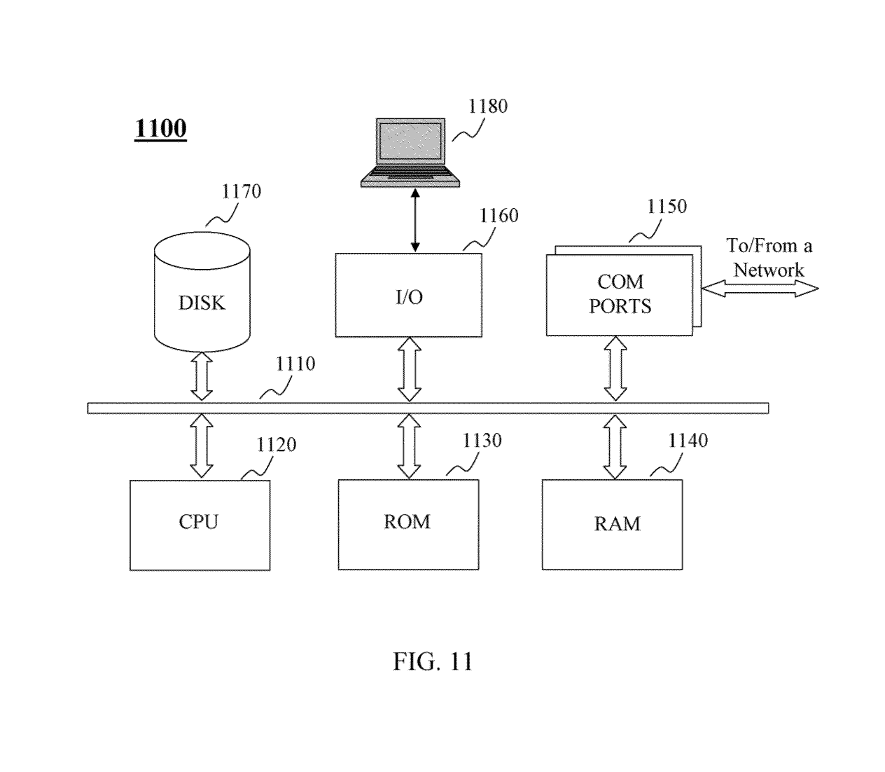

FIG. 11 depicts a general computer architecture on which the present embodiments can be implemented and has a functional block diagram illustration of a computer hardware platform which includes user interface elements. The computer may be a general purpose computer or a special purpose computer. This computer 1100 can be used to implement any components of the search suggestion engine described herein. For example, the generation of search suggestions and provision of web page previews, as well as ranking of search suggestions and processing to extract terms from web pages, can all be implemented on a computer such as computer 1100, via its hardware, software program, firmware, or a combination thereof. Although only one such computer is shown, for convenience, the computer functions relating to development and hosting of applications may be implemented in a distributed fashion on a number of similar platforms, to distribute the processing load.

The computer 1100, for example, includes COM ports 1150 connected to and from a network connected thereto to facilitate data communications. The computer 1100 also includes a central processing unit (CPU) 1120, in the form of one or more processors, for executing program instructions. The exemplary computer platform includes an internal communication bus 1110, program storage and data storage of different forms, e.g., disk 1170, read only memory (ROM) 1130, or random access memory (RAM) 1140, for various data files to be processed and/or communicated by the computer, as well as possibly program instructions to be executed by the CPU. The computer 1100 also includes an I/O component 1160, supporting input/output flows between the computer and other components therein such as user interface elements 1180. The computer 1100 may also receive programming and data via network communications.

Hence, aspects of the methods of developing, deploying, and hosting applications that are interoperable across a plurality of device platforms, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated schedules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a server or host computer into the hardware platform(s) of a computing environment or other system implementing a computing environment or similar functionalities in connection with generating explanations based on user inquiries. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media includes dynamic memory, such as a main memory of such a computer platform. Tangible transmission media includes coaxial cables, copper wire, and fiber optics, including wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic take, any other magnetic medium, a CD-ROM, DVD or DVD-ROM, any other optical media, punch card paper tapes, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the embodiments of the present disclosure are amenable to a variety of modifications an/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as firmware, a firmware/software combination, a firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim and all applications, modifications and variations that fall within the true scope of the present teachings.

1. A method implemented on at least one computing device, each computing device having at least one processor, storage, and a communication platform connected to a network for providing search suggestions, the method comprising:
analyzing a webpage;
extracting terms from the webpage based on analyzing the webpage; and
generating at least one search suggestion based on the extracted terms from the webpage, wherein each of the at least one search suggestion is actionable and represents a search term or a search phrase.

2. The method of claim 1, wherein analyzing a webpage comprises:
determining terms of interest on the webpage.

3. The method of claim 1, wherein extracting terms from the webpage comprises:
extracting terms based on at least one trained classifier.

4. The method of claim 3, wherein the at least one trained classifier comprises: a first classifier to detect the probability of an ambiguity in a term, and a second classifier to detect the probability of a term representing a theme.

5. The method of claim 1, wherein generating at least one arch suggestion based on the extracted terms comprises:
ranking each of the at least one search suggestion based on a plurality of parameters.

6. The method of claim 5, wherein ranking each of the at least one search suggestion comprises:
determining the plurality of parameters each representing a search inducingness factor;
determining a relevance of each of the at least one search suggestion based on the plurality of parameters; and
ranking each of the at least one search suggestion based on the determined relevance of each of the at least one search suggestion.

7. The method of claim 1, further comprising:
generating at least one web page preview corresponding to one of the at least one search suggestion in response to a selection of the one of the at least one search suggestion.

8. A system having at least one processor, storage, and a communication platform connected to a network for providing search suggestions, comprising:
an analysis unit configured for analyzing a webpage;
an extraction unit configured for extracting terms from the webpage based on analyzing the webpage; and
a suggestion generation unit configured for generating at least one search suggestion based on the extracted terms from the webpage, wherein each of the at least one search suggestion is actionable and represents a search term or a search phrase.

9. The system of claim 8, wherein the analysis unit is further configured for determining terms of interest on the webpage.

10. The system of claim 8, wherein the extraction unit is further configured for extracting terms based on at least one trained classifier.

11. The system of claim 10, wherein the at least one trained classifier comprises: a first classifier to detect the probability of an ambiguity in a term, and a second classifier to detect the probability of a term representing a theme.

12. The system of claim 8, wherein the suggestion generation unit is further configured for ranking each of the at least one search suggestion based on a plurality of parameters.

13. The system of claim 12, wherein the suggestion generation unit is further configured for: determining the plurality of parameters each representing a search inducingness factor; determining a relevance of each of the at least one search suggestion based on the plurality of parameters; and ranking each of the at least one search suggestion based on the determined relevance of each of the at least one search suggestion.

14. The system of claim 8, further comprising:
a web page preview unit configured for generating at least one web page preview corresponding to one of the at least one search suggestion in response to a selection of the one of the at least one search suggestion.

15. A machine readable non-transitory and tangible medium having information recorded for providing search suggestions, wherein the information, when read by the machine, causes the machine to perform the steps comprising:
analyzing a webpage;
extracting terms from the webpage based on analyzing the webpage; and
generating at least one search suggestion based on the extracted terms from the webpage, wherein each of the at least one search suggestion is actionable and represents a search term or a search phrase.

16. The machine readable non-transitory and tangible medium of claim 15, wherein the information for analyzing a webpage comprises information, when read by the machine, causes the machine to further perform the step of:
determining terms of interest on the webpage.

17. The machine readable non-transitory and tangible medium of claim 15, wherein the information for extracting terms from the webpage comprises information, when read by the machine, causes the machine to further perform the step of:
extracting terms based on at least one trained classifier.

18. The machine readable non-transitory and tangible medium of claim 17, wherein the at least one trained classifier comprises: a first classifier to detect the probability of an ambiguity in a term, and a second classifier to detect the probability of a term representing a theme.

19. The machine readable non-transitory and tangible medium of claim 15, wherein the information for generating at least one search suggestion based on the extracted terms comprises information, when read by the machine, causes the machine to further perform the step of:
ranking each of the at least one search suggestion based on a plurality of parameters.

20. The machine readable non-transitory and tangible medium of claim 19, wherein the information for ranking each of the at least one search suggestion comprises information, when read by the machine, causes the machine to further perform the steps of:
determining the plurality of parameters each representing a search inducingness factor;
determining a relevance of each of the at least one search suggestion based on the plurality of parameters; and
ranking each of the at least one search suggestion based on the determined relevance of each of the at least one search suggestion.

21. The machine readable non-transitory and tangible medium of claim 15, wherein the information, when read by the machine, further causes the machine to perform the step comprising:
generating at least one web page preview corresponding to one of the at least one search suggestion in response to a selection of the one of the at least one search suggestion.

22. The method of claim 1, wherein each of the at least one search suggestion provides a suggestion for a user to submit a search request.
